(19) United States
(12) Patent Application Publication
(10) Pub. No.: US 2001/0048869 A1
(43) Pub. Date: Dec. 6, 2001

(54) Method and appratus for delivering large containers of goods, especially warehoused goods, to an out-processing station or transfer station

(76) Inventor: Leen-Pieter de Jong, Varsseveld (NL)

Correspondence Address: ROBERT W. BECKER & ASSOCIATES, Suite B, 11896 N. Highway 14, Tijeras, NM, 87059, US

(21) Appl. No.: 09/850,921

(22) Filed: May 7, 2001

(30) Foreign Application Priority Data
May 23, 2000 (EP) EP 00110883.6

(51) Int. Cl. B65G 65/00

(52) U.S. Cl. 414/286

(57) ABSTRACT

A method and apparatus are provided for delivering large containers of goods, especially warehoused goods such as pallets, to a transfer or out-processing station.

A large container is placed on a conveyor means positioned temporarily at the beginning of an inclined delivery segment that leads to the out-processing or transfer station, the conveyor means being movable in the direction of the delivery segment. The conveyor means, together with the large container placed thereon are moved along the inclined delivery segment in the direction of the out-processing or transfer station, whereby the movement of the conveyor means is effected by the gravity exerted by the large container.

### BACKGROUND OF THE INVENTION

The present invention relates to a method for delivering large containers of goods, especially warehoused goods such as pallets, to an out-processing station or transfer station. The invention furthermore relates to an apparatus for delivering large containers of goods, especially warehoused goods such as pallets, to an out-processing station or transfer station, and includes an inclined delivery segment that leads into the out-processing station and that has at least one conveyor means for moving the large containers.

When warehousing goods or similar articles it is generally customary to consolidate those goods that are small in volume in larger containers, these containers then being stored separately, for example on racks or shelves. Large containers in the context of this invention are especially pallets, wire cages, boxes, and similar containers that are suitable for receiving a plurality of small articles.

When a certain number of articles that have been combined in large containers need to be removed from storage, it is necessary to remove the large container from storage, for example from the rack, to open the large container, and to remove the desired number of articles that are to be taken out of storage. This process is also known as out-processing, whereby the articles combined in the large containers are called warehoused goods.

Usually the large containers are delivered to an out-processing station for this purpose, at which station the actual out-processing is then performed manually or automatically.

It is known during transport of large containers on pre-specified conveyor segments to provide transfer stations at which the containers are removed from a conveyor segment and are forwarded for further transport, for example on a different conveyor segment to another transport means, or are even forwarded by conventional transport means such as by truck.

It is known in the prior art to remove the large container from storage using appropriate aids, for example a storage and retrieval unit, to place it on a delivery segment that leads into the out-processing station or transfer station, and to then transport it via transport means to the out-processing station or transfer station. The prior art provides several options for this.

This movement along the delivery segment can be accomplished by means of motor-driven transport means. Motor-driven conveyor belts, for instance, are provided for this purpose.

Another approach is to use the gravity exerted by the large container itself to move the large container along the delivery segment. Provided for this is a delivery segment that is inclined to the horizontal and that has a roller conveyor as transport means. The large container, such as a pallet, is first placed on the roller conveyor at the beginning of the delivery segment and, due to its own gravity, moves along the individual rollers of the roller conveyor in the direction of the out-processing station or transfer station to which the delivery segment leads. Once there, out-processing of the desired quantity of articles can begin, or the large container is transferred, as described above. In the case of out-processing, if the large container is completely emptied, it is removed from the out-processing station and another large container can be delivered along the delivery segment. The same applies when a transfer takes place.

It is furthermore known to dimension the delivery segments such that on the far side of the out-processing station one or more large containers, such as pallets, can be set aside and which, once the large container located in the out-processing station or transfer station has been processed and removed or transferred out of the out-processing station, can be brought into the out-processing or transfer station that is now unoccupied. The advantage of such a solution is that this system can realize the so-called first-in/first-out technique, in which a large container that is the first placed on the delivery segment is also the first to be out-processed or transferred. This is particularly important for articles with limited shelf-life, since, due to their limited shelf-life, care must be taken that the articles that are placed in storage first are the first to be removed from storage in order that a maximum tolerable period of time is not exceeded.

However, it has been determined that in particular in connection with palletized goods, there are specific problems associated with the delivery segments that have roller conveyors integrated therein and that work using the gravity of the large containers themselves. The various commonly-used pallets (such as the Europallet or the GMA pallets conventionally used in the United States) are usually made of wood. When a pallet is in the transfer or out-processing station of an apparatus known from the prior art that has roller conveyors, and if another pallet has been placed on the roller conveyor in a wait position, the wood located on the under side of the pallet that is in contact with the rollers of the roller conveyor places on the roller conveyor a load with the weight produced by the palletized goods. This causes the rollers of the roller conveyor to press into the wood of the pallet so that some of the rollers sink into the wood of the pallet. If the out-processing of the pallet that is in the out-processing station lasts for an extended period, or if the out-processing is interrupted by a break in work for an extended period (for instance, a weekend), or if the pallet remains in the transfer station for an extended period until it is transferred, the rollers of the roller conveyor can press relatively deep into the wood on the underside of the pallet. Then, if the pallet located in the transfer or out-processing station is emptied and/or removed, and if the next pallet set on the roller conveyor in the direction of the transfer or out-processing station is to follow, it is possible that the rollers of the roller conveyor have been pressed so far into the wood on the underside of the pallet that the pallet can no longer be moved using the rollers of the roller conveyor. In fact, it can be retained in its position by the rollers that are pressed into the wood.

Instead of the pallet continuing in the direction of the transfer or out-processing station due to its own gravity, as planned, additional measures must now be undertaken. In the worst case scenario, when even additional force exerted on the pallet does not release the pressed-in rollers of the roller conveyor from the under side of the pallet, the pallet must be at least partially out-processed then and there, in other words, on the delivery segment, so that it is possible to move the pallet in the direction of the transfer or out-processing station by removing weight from it.

Not only do such occurrences interrupt transfer or out-processing operations, they also tie up resources that have to be used to release the pallet that is stuck on the roller conveyor.

It is therefore an object of the present invention is to provide a method for delivering large containers of goods, especially warehoused goods such as pallets, to an out-processing station or transfer station, which method employs the gravity of the large container as a drive and which method facilitates a smooth process, especially after the large container experiences extended standing times on the delivery segment. It is furthermore an object of the present invention to provide an apparatus of the type described in the foregoing with which such a method can be performed.

### BRIEF DESCRIPTION OF THE DRAWINGS

This object, and other objects and advantages of the present invention, will appear more clearly from the following specification in conjunction with the accompanying schematic drawings, in which:

FIGS. 1a and 1b illustrate the sequence of events in the inventive method for using a two-pallet system;

FIGS. 2a through 2c illustrate the sequence of events in the inventive method in a three-pallet system;

FIG. 3 illustrates the structure of an apparatus in accordance with the present invention for delivering large containers of goods, especially warehoused goods, to an out-processing station or transfer station in four different positions;

FIG. 4 illustrates two different exemplary embodiments for a lowering mechanism for adjusting the height of the bearing surface of a conveyor cart in the invention;

FIGS. 5 and 5b are schematic representations of an embodiment of an apparatus in accordance with the invention with two parallel-running carts for a two-pallet system; and

FIGS. 6a through 6c are schematic representations of an embodiment of an apparatus in accordance with the invention with two parallel-running cart pairs in a three-pallet system.

### SUMMARY OF THE INVENTION

For achieving the object in terms of the method, the invention suggests a method for delivering large containers of goods, especially warehoused goods such as pallets, to an out-processing station or transfer station, and has the following steps:

placing a large container on a conveyor means positioned temporarily at the beginning of an inclined delivery segment that leads to the out-processing station or transfer station, said conveyor means being movable in the direction of the delivery segment;

moving the conveyor means together with the large container placed thereupon along the inclined delivery segment in the direction of the out-processing station or transfer station, whereby the movement of the conveyor means is effected by the gravity exerted by the large container.

By placing the large container on a conveyor means that is positioned temporarily at the beginning of an inclined delivery segment that leads into the out-processing station or transfer station, and having the conveyer means then move together with the large container in the direction of the out-processing station or transfer station, the container on the conveyor means cannot become stuck by deformation, as can occur due to the rollers of the roller conveyor pressing into the wood on the underside of the pallet, even when the large container experiences extended dwell times on the conveyor means, for instance because the out-processing station or transfer station is still occupied with a large container that must first be completely out-processed or transferred. The large container is placed onto the surface of the conveyor means, whereby the conveyor means itself moves with the large container placed thereupon in the direction of the out-processing station or transfer station. Thus the conveyor means can be caused to move again with no problem when the delivery of the large container to the out-processing station or transfer station is to be continued after an extended waiting time in the delivery segment. Furthermore, the surface of the transport means can be designed advantageously so that even when the large container experiences extended standing times on the conveyor means it is possible to reliably prevent damage to the large container caused by irregularities in the surface of the conveyor.

Furthermore, with an out-processing station or transfer station that is occupied by one large container the inventive method provides for placing at least one additional large container on conveyor means located in the delivery segment and moving it into the wait position. In accordance with one embodiment of the inventive method, for this reason it is provided that in an out-processing station or transfer station that is occupied with an additional large container, the conveyor means remains with the large container placed thereupon in a wait position provided in the delivery segment, from which position it delivers the large container to the out-processing station or transfer station when the out-processing station or transfer station is no longer occupied.

Preferably at least one cart that is movable on a track provided in the delivery segment is employed as the conveyor means for employment in the inventive method. However, a section of a continuous belt or chain that runs along the delivery segment and that is movable via reversing elements can also be selected as the conveyor means. If the delivery segment is laid out such that one large container can be in the out-processing station or transfer station and only one additional large container can be located in the wait position in the delivery segment at the same time, providing one cart, or providing one continuous belt or chain that extends across the entire delivery segment into the out-processing station or transfer station, is sufficient for performing the method. However, if, in addition to the large container located in the out-processing station or transfer station, two additional large containers are positioned in wait positions in the delivery segment, two carts, or two continuous belts or chains arranged successively in the direction of the delivery segments, are necessary for performing the method. If the object is achieved using continuous belts or chains, and if two large containers are to be able to remain in wait positions in the delivery segment, then two belts or chains arranged successively are necessary. A first continuous belt or chain then extends over a length along the delivery segment, said length being equal to the total length of at least two large containers, adjacent to which is a second continuous belt or chain that extends over the approximate length of one large container and that constitutes the out-processing station or transfer station. Transfer of the large container to be transported occurs between the two adjacent chains or belts.

The incline of the delivery segment should be selected depending on the transport means used such that the weight of the large container on the components arranged parallel to the delivery segment is sufficient to overcome the friction of the conveyor means and to produce a weight-actuated drive in the direction of the out-processing station or transfer station.

If a cart is used as the conveyor means, then in accordance with an additional advantageous proposal of the invention, it is provided that the large container in the out-processing station or transfer station be moved by the cart to a take off mechanism, and that the emptied cart then be returned to its starting position at the beginning of the conveyor segment. Thus the cart used as the transport means is available for delivering an additional large container to the out-processing station or transfer station. As long as the large container placed on the take off mechanism in the out-processing station or transfer station blocks the cart, the cart can now remain in a wait position with another large container thereupon.

In accordance with an additional feature of the present invention, moving the large container onto the take off mechanism is accomplished by lowering a support or bearing surface of the cart upon which the large container rests. The cart thus moves with the large container placed on the bearing surface into the out-processing station or transfer station which is provided with a take off mechanism and at that point the bearing surface with the large container located thereupon is, for example automatically, triggered to lower until it is below the level of the take off mechanism so that the large container now rests on the take off mechanism and no longer rests on the bearing surface of the cart.

It is furthermore suggested pursuant to the present invention that the cart thus emptied be returned to its starting position using a force produced by a counterweight or a spring, said force being directed toward the starting position. Thus it is not necessary to have a motorized drive in this instance, either, and the cart is simply returned backwards along the track of the inclined delivery segment to the higher level of the starting position located at the beginning of the delivery segment by an appropriately embodied spring or a counterweight determined by the requirements.

For achieving the object of the inventive apparatus, it is suggested that with the present invention in an apparatus of the type cited in the foregoing that the at least one conveyor means be movable along the delivery segment. Thus it is possible to place the large container on the conveyor means and to move the conveyor element together with the large container in the direction of the out-processing station or transfer station using the gravity exerted by the large container.

In accordance with additional features of the apparatus, for example at least one cart or at least one section of a continuous belt or chain, running along the delivery segment and movable via reversing elements, can be selected for conveyor means.

What has been presented for the inventive method also applies for the inventive apparatus, namely, that when, in addition to a large container located in the out-processing station or transfer station, an additional large container should be receivable in a wait position in the delivery segment, it is sufficient to provide either one cart or one continuous belt or chain, but that when, in addition to a large container located in the out-processing station or transfer station, two additional large containers are to be capable of being disposed in wait positions along the delivery segment, at least two carts or two continuous belts or chains as described in the foregoing must be provided.

If a cart is provided as the conveyor means, an additional feature of the present invention suggests that the cart have a bearing surface for a large container, which bearing surface is adjustable in terms of the distance between it and the wheels of the cart. Thus the large container can be automatically moved from the bearing surface to a take off mechanism provided, in accordance with an additional feature of the invention, in the out-processing station or transfer station.

In accordance with an additional feature of the present invention, provided at the ends of the delivery segment are stops that trigger a change in the distance between the bearing surface of the cart and its wheels when the cart strikes the stops. Thus the bearing surface for the large container can be lowered on the cart as soon as the cart strikes the stop in the out-processing station or transfer station so that the large container is automatically moved to the take off mechanism. When the cart has returned and then strikes the second stop provided at the beginning of the delivery segment, it is provided that the bearing surface returns to its higher position so that it is ready to receive an additional large container.

Additional advantages and features of the present invention will be described in detail subsequently.

### DESCRIPTION OF PREFERRED EMBODIMENTS

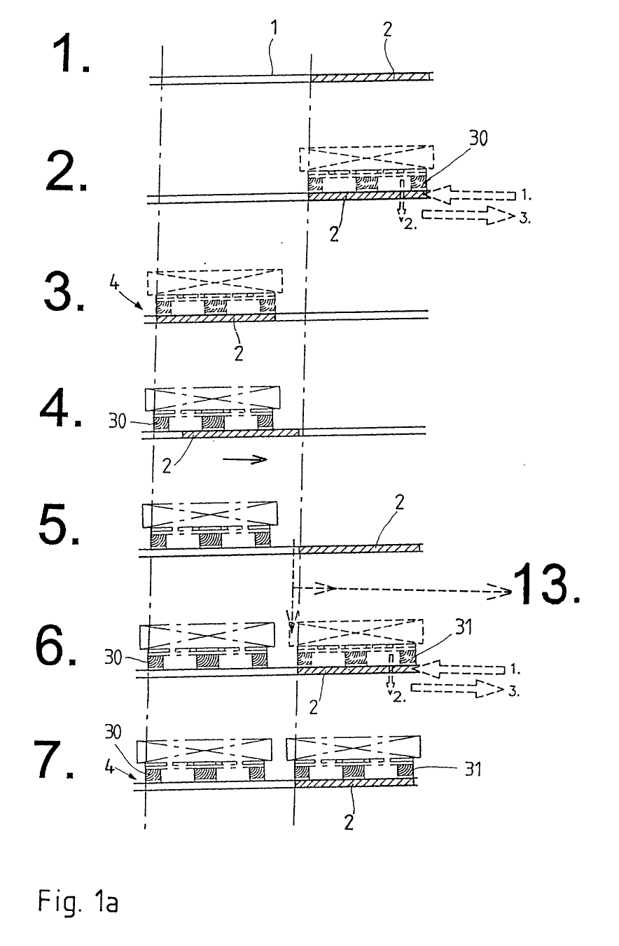

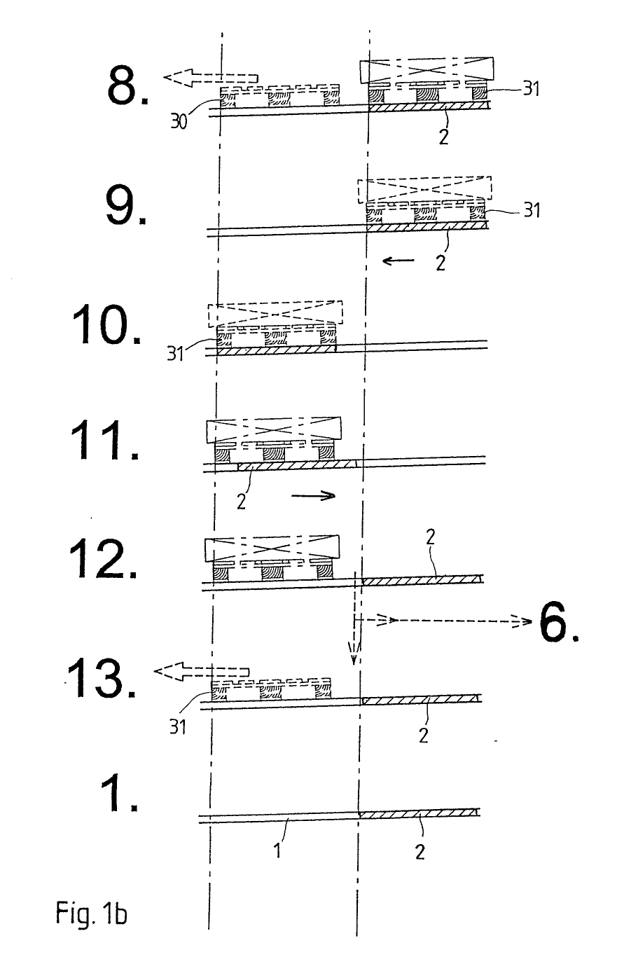

Referring now to the drawings in detail, FIGS. 1a and 1b illustrate the sequence of events in a method in accordance with the invention in a two-pallet system. A two-pallet system is a system in which, while one pallet is located in the transfer or out-processing station, another pallet can be delivered to the apparatus and remains in a wait or holding position in the delivery segment. FIGS. 1a and 1b illustrate the method using 13 different steps. The inclined delivery segment 1 is shown for each of the steps.

In step 1, at the beginning of the method, a conveyor means 2 is located in a starting position at the upper end of the inclined delivery segment 1. In step 2, a first pallet 30 is placed on the conveyor means. This can be done, for example using a storage and retrieval unit (SRV), as indicated by the dashed-line arrow. The SRV with the pallet 30 moves in the direction of the conveyor means 2 located in the starting position, lowers the pallet and places it onto the conveyor means 2, and is then withdrawn, without the pallet, from the area of the delivery segment.

The gravity exerted by the pallet 30 now causes the conveyor means 2 to move along the inclined delivery segment 1 in the direction of a transfer or out-processing station 4.

As illustrated, in method step 3 the conveyor means 2 with the pallet 30 thereupon arrives at the transfer or out-processing station. Now the pallet 30 is placed on a take off mechanism and a restoring force drives the conveyor means 2 back to the starting position. This is indicated in method step 4.

In step 5, the pallet 30 is on a take off or deposit mechanism in the transfer or out-processing station 4, and the conveyor means 2 has arrived at its starting position. As indicated by the alternate arrow, step 13 can immediately follow step 5 as illustrated. Step 13 will be described later.

Step 6 occurs if step 13 does not follow step 5. An SRV places another pallet 31 onto the conveyor means 2 located at the starting position. The conveyor means 2 with the pallet 31 thereupon does not move at all or moves only slightly in the direction of the transfer or out-processing station because the latter is still occupied by the pallet 30.

Step 8 shows that the pallet 30 that is still located on the take off mechanism has been completely out-processed and removed from the system. Alternatively, the pallet can have been transferred to a transfer station. Now step 9 begins; as shown, the gravity of the pallet 31 causes the conveyor means 2 with the pallet 31 thereupon to move in the direction of the transfer or out-processing station. Once there, the pallet 31 is moved to the take off mechanism (step 10), which is now unoccupied, and the conveyor means 2 returns to its starting position in a manner analogous to step 4.

Once it arrives there the conveyor means 2 is ready to receive another pallet. This is illustrated in step 12. Then, as indicated by the alternate arrow, step 6 can follow, whereby another pallet, other than the pallet 31 illustrated in step 6, can be placed on the conveyor means 2. Alternatively, step 13 can occur, in which step the pallet 31 (or the pallet 30, if step 13 immediately follows step 5) is completely out-processed and removed from the system or transferred. Now the method has returned to its starting situation.

Of course the pallet next placed at the starting position of the transport means 2 can be removed from the delivery segment in reverse during any method step. This can be done, for example with an SRV. Thus, for instance, a pallet that has not been completely emptied can be returned to storage from the out-processing station if this is necessary.

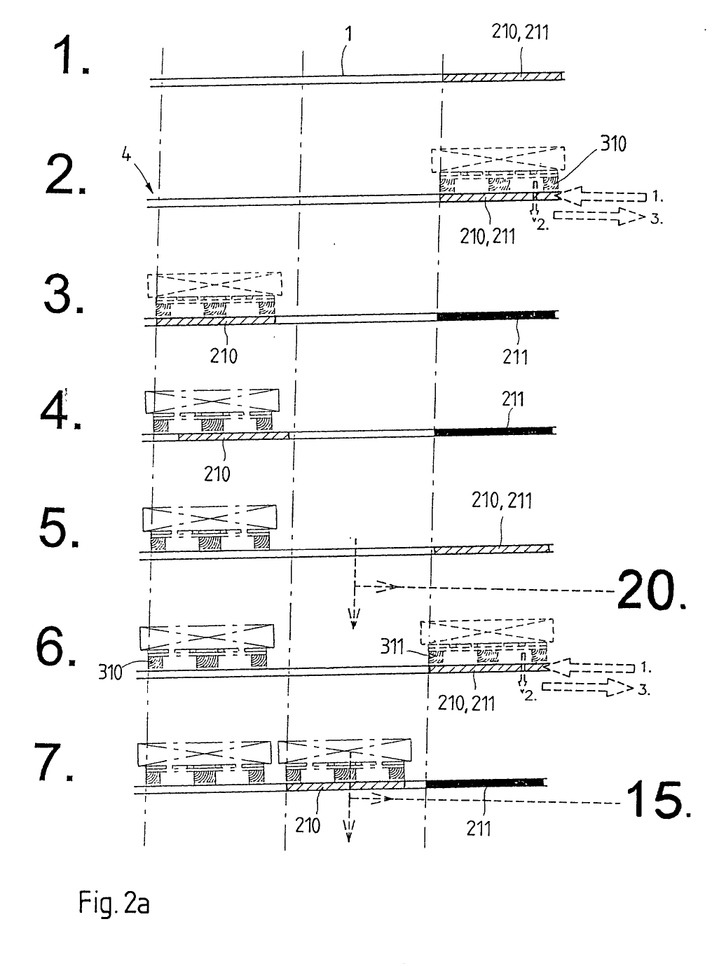

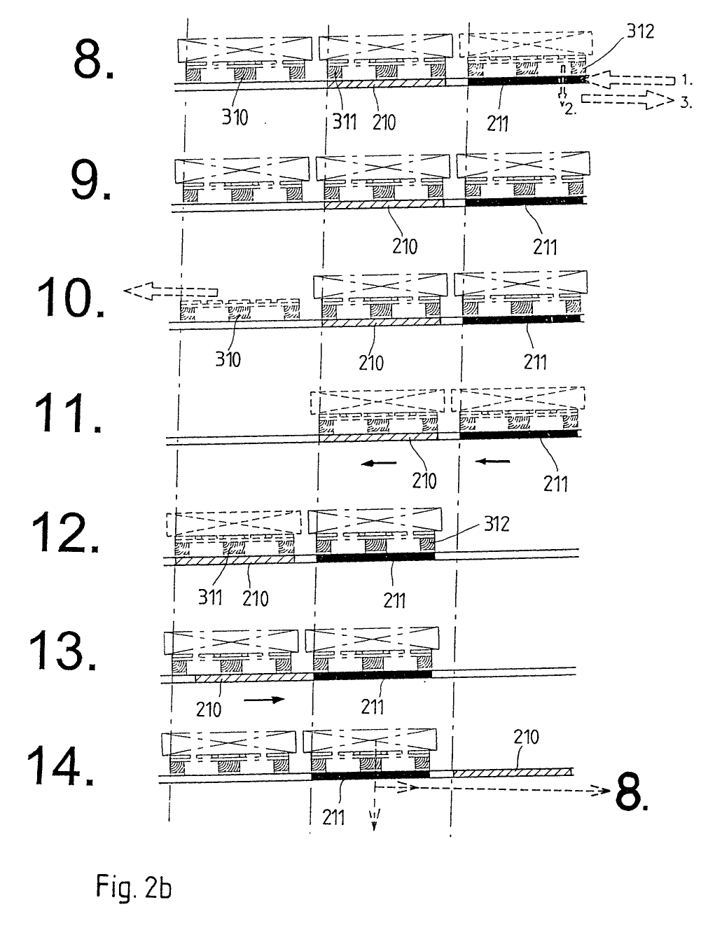

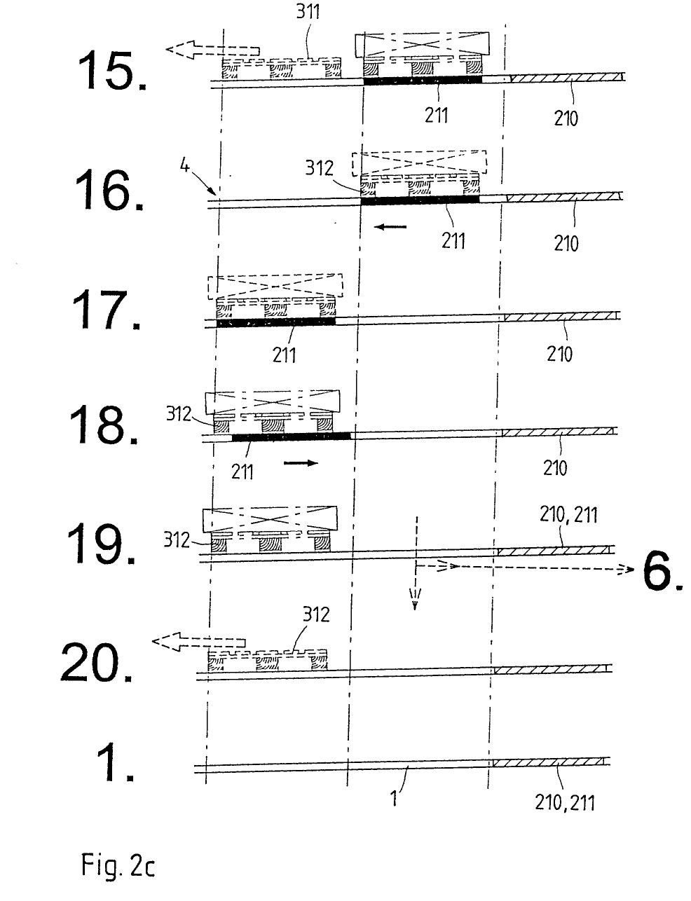

FIGS. 2a through 2c illustrate individual steps in the method for a three-pallet system. A three-pallet system should be understood to mean a system in which, in addition to a pallet located in the transfer or out-processing station, two additional pallets can be placed in successive wait positions along the delivery segment. In contrast to the method described above, illustrated in FIGS. 1a and 1b, two conveyor means 210 and 211 are provided in the delivery segment 1 in the method for a three-pallet system illustrated here.

At the beginning of the method, illustrated in step 1, both conveyor means 210 and 211 are shown at the beginning of the delivery segment 1 in the starting position. Conveyor means 210 and 211 are distinguished in that only conveyor means 210 can receive a pallet when both conveyor means are in the starting situation. Conveyor means 211 cannot receive a pallet until conveyor means 210 is not located in the starting position.

As illustrated in step 2, an SRV, for instance, places a pallet 310 onto the conveyor means 210. The gravity exerted by the pallet then causes the conveyor means 210 to move along the inclined delivery segment 1 in the direction of the transfer or out-processing station 4 until the pallet 310 finally arrives at the transfer or out-processing station, as shown in step 3.

Now the conveyor means 210 moves the pallet onto a take off mechanism, and the conveyor means 210 returns to its starting position, as shown in step 4, driven by a restoring force. The conveyor means 211 has remained in its starting position during all of these enumerated method steps.

As illustrated in step 5, only the first pallet 310 is moved onto the take off mechanism in the transfer or out-processing station 4, and if the two conveyor means 210 and 211 are back in the starting position, step 20 (described later) can now occur immediately, as indicated by the alternate arrow. However, if step 6 occurs now, another pallet 311 is placed, for instance by means of an SRV, onto the conveyor means 210 located at the beginning of the delivery segment 1 in the starting position.

The gravity of the pallet 311 now causes the conveyor means 210 to again move in the direction of the transfer or out-processing station. However, since the transfer or out-processing station is still occupied by the pallet 310, the conveyor means 210 with the pallet 311 placed thereupon moves only to a wait position in front of the transfer or out-processing station, as illustrated in step 7. The conveyor means 211 is still in its starting position.

After the illustrated step 7, the method can jump ahead directly to step 15, which is described later. Otherwise step 8 occurs, in which a pallet 312 is again brought to the delivery segment 1, for instance by means of an SRV. The third pallet 312 is now placed onto the only conveyor means 211 still located in the starting position. The delivery segment 1, including the transfer or out-processing station 4, is now occupied by three pallets and is thus completely full. The conveyor means 211 with the pallet 312 placed thereupon does not move, or moves only slightly, in the direction of the transfer or out-processing station because the delivery segment in the direction of the transfer or out-processing station 4 is already occupied by two pallets.

As illustrated in step 10, if the first pallet 310 is now completely out-processed and removed from the system or if it is transferred, both conveyor means 210 and conveyor means 211 can be driven by the gravity of pallets 311 and 312, respectively, in the direction of the transfer or out-processing station 4. The conveyor means 210 with the pallet 311 placed thereupon reaches the transfer or out-processing station and moves the pallet onto a take off mechanism there.

The conveyor means 211 with the pallet 312 placed thereupon occupies the wait position formerly occupied by the conveyor means 210. This is illustrated in step 12. If the pallet 311 is moved onto the take off mechanism, the conveyor means 210 returns to its starting position driven by the restoring force, as illustrated in step 13. Once it arrives there it is ready to receive a pallet, as shown in step 14.

The method can jump to step 8, as indicated by the alternate arrow; however, the designations for conveyor means 210 and 211 should be switched in this and subsequent steps.

If the method now continues with the next step (15), as illustrated, the next pallet 311 moved onto the take off mechanism is completely out-processed and removed or transferred from the system. In this case, the conveyor means 211 with the pallet 312 placed thereupon moves in the direction of the transfer or out-processing station 4 driven by the gravity of the pallet 312. Step 16 illustrates this. As illustrated in step 17, the conveyor means 211 now moves the pallet 312 onto the take off mechanism. Then a restoring force causes the conveyor means 211 to return without the pallet 312 to the starting position. As illustrated in step 19, both conveyor means 210, 211 are now again in the starting position and one pallet 312 is located in the transfer or out-processing station.

At this point, the method can continue as illustrated in step 6, which is again indicated by the alternate arrow, i.e., another pallet can be placed on a conveyor means, namely the conveyor means 210, or the method continues in step 20. Step 20 illustrates that the only pallet 312 located in the transfer or out-processing station 4 (or pallet 310, if step 20 immediately follows step 5 directly) is completely out-processed and removed from the system or transferred. Now the method has returned to the starting situation illustrated in step 1.

Even in the method illustrated in FIGS. 2a through 2c it is of course possible to retrieve from the system the rear-most pallet, for instance by means of a SRV. Thus, for instance, a pallet that has only been half emptied can be retrieved from the transfer or out-processing station by means of an SRV.

FIG. 3 illustrates one option for the embodiment of a conveyor means. It is shown in four different operational positions. A cart 5 runs on the inclined delivery segment 1, at the end of which is a take off mechanism 7. The cart has rollers 10 by means of which it can be moved with low friction on the delivery segment 1. The cart has a bearing or support surface 6, the height of which can be adjusted between two positions. If the cart is at the beginning of the delivery segment, a pallet 3 can be placed upon the bearing surface 6, and gravity causes the cart to move, as shown in the second diagram, in the direction of the take off mechanism 7. A stop 8 is provided at the end of the delivery segment 1. If the cart 5 with the pallet 3 rolling down the inclined delivery segment strikes the stop 8, the bearing surface 6 lowers, and the pallet 3 with the warehoused goods located thereupon is moved onto the take off mechanism 7. The third diagram in this figure illustrates the situation in which the cart 5 with the lowered bearing surface 6 returns to the starting position. Another stop 9 is located in the starting position; it causes the bearing surface 6 to be raised when the cart strikes this stop 9. The cart is now ready to receive another pallet.

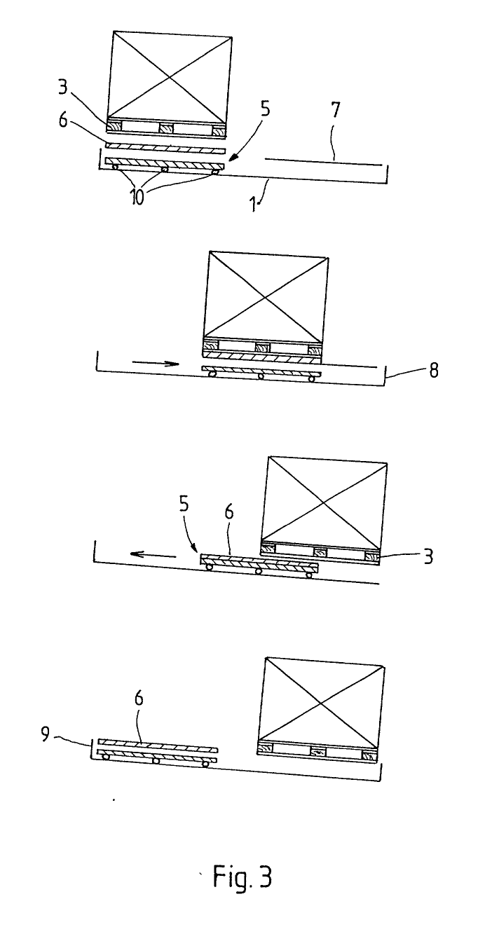

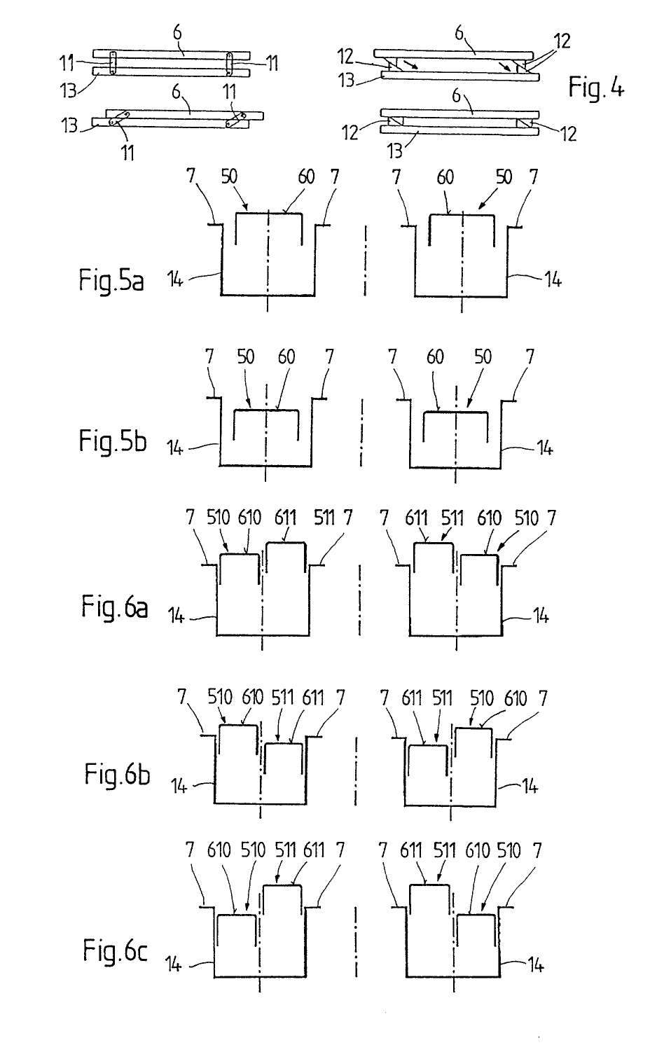

FIG. 4 illustrates two different ways to make it possible for the height of the bearing surface 6 of the cart 5 to be adjusted. The first option illustrated here is to connect the bearing surface 6 to the cart chassis 13 via two rigid coupling members 11 that are attached in an articulated manner to both the cart chassis 13 and the bearing surface. This embodiment is illustrated in both the raised position and in the lowered position. The second option illustrated here for the lowering mechanism is to connect the cart chassis 13 to the bearing surface 6 via slide members 12. The slide members 12 have slide surfaces inclined to the bearing surface 6; when the slide members are displaced relative to each other, the bearing surface 6 moves to a raised or lowered position relative to the cart chassis 13. This embodiment is also illustrated in both the raised position and in the lowered position. Another option would be to provide telescoping coupling members.

FIGS. 5a and 5b illustrate one possible embodiment of the delivery segments provided with carts for a two-pallet system. The delivery segment has two parallel and adjacent guide tracks 14 for carts 50 running mutually independent and parallel. The guide tracks 14 in this example are U-shaped and at each of the vertical legs have outward-guided angled-off portions that serve as the take off mechanism 7. FIG. 5a illustrates the situation in which the carts are located in the starting position. In terms of height, the bearing surfaces 60 of the carts 50 project over the angled-off portions of the guide tracks 14 that act as the take off mechanism 7. Thus a pallet can be placed on the two deposit or bearing surfaces 60 of the carts 50, and the carts can be moved with the pallet placed thereupon or with another large container in the direction of the transfer or out-processing station. FIG. 5b illustrates the situation in which the bearing surfaces 60 of the carts 50 are lowered. A pallet (not shown) is moved to the guide sections of the guide tracks 14 acting as the take off mechanism 7, and the carts 50 return without the pallets to the starting position, where their bearing surfaces 60 are raised again.

Analogous to FIGS. 5a and 5b, FIGS. 6a through 6c illustrate a solution for the three-pallet system. Again, two parallel guide tracks 14 are arranged along the delivery segment, whereby in this case two carts 510 and 511 with corresponding bearing surfaces 610 and 611 are provided in each track.

The guide tracks are also U-shaped in this case, and at the end of their vertical legs have outwardly projecting angled-off portions acting as a take off mechanism 7 for pallets or other large containers. FIG. 6a illustrates the starting position in which bearing surfaces 610 and 611 for carts 510 and 511 are in the raised position. It should be noted that the bearing surfaces 611 of the interior two carts 511 are higher than the bearing surfaces 610 of the exterior two carts 510. Thus a pallet or other large container introduced into the apparatus would be placed onto the bearing surfaces 611 of the carts 511 and the carts 511 would move with the pallet placed thereupon or with another large container in the direction of the transfer or out-processing station. If the interior two carts 511 are not located in the starting position, but rather are in a wait position with the large container placed on the bearing surfaces 611, a large container then introduced can be placed onto the bearing surfaces 610 of the two carts 510.

FIG. 6b illustrates how the bearing surfaces 611 of the interior two carts 511 in the lowered condition are located below the level of the bent over end sections of the legs of the U-shaped guide tracks 14 acting as a take off mechanism 7. A pallet transported on the bearing surfaces 611 into the out-processing station is now moved onto the take off mechanism 7, and the carts 511 are returned to their starting position. It should be noted that the bearing surfaces 611 of the carts 511 are clearly lowered below the level of the bearing surfaces 610 of the exterior carts 510 so that the carts 511 can be moved with no problem under any pallet that has been moved to the bearing surfaces 610 located with the cart 510 in a wait position.

FIG. 6c illustrates the reverse situation in which the bearing surfaces 610 of the exterior carts 510 are lowered below the level of the take off mechanism 7 and below the level of the raised bearing surfaces 511 so that the carts 510, after the pallet or another large container has been deposited in the transfer or out-processing station, can be returned with no problem to the starting position. In the starting position, the lowered bearing surfaces 610 and 611 of the exterior two carts 510 or of the interior two carts 511 are returned to the raised position.

In FIGS. 5a through 6c it should be noted that there is an intermediate space between the guide tracks 14 into which a functional element of an SRV can be introduced in order to lift a pallet or other large container in the system and, for instance, return it to a storage rack.

The specification incorporates by reference the disclosure of European priority document EP 00110 883.6 of May 23, 2000.

The present invention is, of course, in no way restricted to the specific disclosure of the specification and drawings, but also encompasses any modifications within the scope of the appended claims.

What I claim is:

1. A method for delivering large containers of goods to an out-processing or transfer station (4), said method including the steps of:
temporarily positioning a conveyor means (2, 210, 211) at a beginning of an inclined delivery segment (1) that leads to said out-processing or transfer station (4), wherein said conveyor means is movable along said delivery segment (1);
placing a large container (3, 30, 31, 310, 311, 312) on said conveyor means; and
moving said conveyor means, with said large container thereon, along said delivery segment in a direction toward said out-processing or transfer station, wherein movement of said conveyor means is effected by gravity exerted by said large container.

2. A method in accordance with claim 1, wherein with an out-processing or transfer station (4) that is occupied with an additional large container (3, 30, 31, 310, 311, 312), said conveyor means (2, 210, 211), with said large container thereon, is retained in a wait position provided in said delivery segment (1), from which position said conveyor means delivers said large container to said out-processing station or transfer station when said out-processing or transfer station (4) is no longer occupied by said additional container.

3. A method in accordance with claim 1, wherein a cart (5, 50, 510, 511) that is movable on a track of said delivery segment (1) is employed as said conveyor means (2, 210, 211).

4. A method in accordance with claim 3, wherein said out-processing or transfer station (4), said large container is deposited from said cart (5, 50, 510, 511) upon a take off mechanism (7), and wherein said thus emptied cart is then returned to the starting position at the beginning of said delivery segment (1).

5. A method in accordance with claim 4, wherein depositing said large container (3, 30, 31, 310, 311, 312) onto said take off mechanism (7) is accomplished by lowering a support surface (6, 60, 610, 611) of said cart (5, 50, 510, 511) upon which said large container (3, 30, 31, 310, 311, 312) rests.

6. A method in accordance with claim 4, wherein said cart (5, 50, 510, 511) is returned to the starting position using a force produced by a counterweight or a spring, said force being directed toward the starting position.

7. A method in accordance with claim 1, wherein a section of a continuous belt or chain that runs along said delivery segment, and that is movable over guide elements, is employed as said conveyor means.

8. An apparatus for delivering large containers of goods to an out-processing or transfer station (4), said apparatus comprising:
an inclined delivery segment (1) that leads to said out-processing or transfer station (4); and
at least one conveyor (2, 210, 211) for receiving a large container (3, 30, 31, 310, 311, 312), wherein said conveyor means is movable along said delivery segment.

9. An apparatus in accordance with claim 8, wherein a cart (5, 50, 510, 511) is provided as said conveyor means (2, 210, 211).

10. An apparatus in accordance with claim 9, wherein a take off mechanism (7) is disposed in said out-processing or transfer station (4) for receiving a large container (3, 30, 31, 310, 311, 312).

11. An apparatus in accordance with claim 10, wherein said cart (5, 50, 510, 511) has a support surface (6, 60, 610, 611) for a large container (3, 30, 31, 310, 311, 312), wherein the height of said support surface can be adjusted relative to wheels (10) of said cart.

12. An apparatus in accordance with claim 11, wherein stops (8, 9) are provided at ends of said delivery segment and trigger an adjustment in a distance between said support surface (6, 60, 610, 611) of said cart (5, 50, 510, 511) and said wheels of said cart when said cart strikes against said stops.

13. An apparatus in accordance with claim 9, which includes a return element for returning said cart (5, 50, 510, 511) to a starting position at the beginning of said delivery segment (1).

14. An apparatus in accordance with claim 8, wherein said conveyor means is in the form of sections of an endless belt or chain that extends along said delivery segment and is movable over guide elements.
